(19) United States
(12) Patent Application Publication
(10) Pub. No.: US 2026/0097514 A1
(43) Pub. Date: Apr. 9, 2026

(54) METHOD FOR GRIPPING AND TRANSFERRING AT LEAST ONE INDIVIDUAL UNIT, AND USE OF A SYSTEM

(71) Applicant: HAVER & BOECKER OHG, Oelde (DE)

(72) Inventors: Andre SIEWECKE, Rheda-Wiedenbrück (DE); Robert HENKE, Oelde (DE); Volker SCHÜTTE, Oelde (DE)

(21) Appl. No.: 19/111,915

(22) PCT Filed: Sep. 14, 2023
(86) PCT No.: PCT/EP2023/075278

§ 371 Date: Mar. 14, 2025

(30) Foreign Application Priority Data
Sep. 16, 2022 (DE) 10 2022 123 762.1

(51) Int. Cl. B25J 9/16

(52) U.S. Cl. CPC B25J 9/1697; B25J 9/163

(57) ABSTRACT

A method for gripping and transferring an individual unit out of a stock of individual units, which are stacked in an offset manner, using a system including a handling device with a gripping device and including a controller, the stock of individual units, which are stacked in an offset manner, is provided on a storage surface. The position and/or orientation of an exposed individual unit on the storage surface is detected by the controller. The handling device and the gripping device are actuated the controller by the ascertained position and/or orientation to grip the individual unit. The gripped individual unit is transferred to a specified location and/or unit. A system including a handling device with at least one gripping device and including a controller is used to grip and transfer an individual unit, the position and/or the orientation of an individual unit on a storage surface detected by the controller.

The present invention relates to a method for gripping and transferring at least one individual unit out of a stock of individual units, which are stacked in an offset manner, using a system comprising at least one handling device with at least one gripper device and comprising at least one controller. Here, at least the stock of individual units, which are stacked in an offset manner, is provided on at least one storage surface. The present invention also relates to the use of a system comprising at least one handling device with at least one such gripper device and comprising at least one controller for gripping and transferring at least one individual unit.

Various devices for gripping and transferring or transporting individual and stacked objects are known in the prior art.

When there is a stock of objects or object stacks, for example stacks of sacks layered on a pallet, e.g., in the region of packing units for filling bulk material into sacks, the stacks are present overlapping in a multiplicity of layers.

The problem with automatically gripping a stack of sacks is that only the uppermost and thus exposed stack of sacks must be gripped so that the other stacks of sacks do not slip uncontrollably or even fall off the pallet.

It is therefore the object of the present invention to improve the automatic gripping of individual objects and/or stacks or bundles of objects.

This object is achieved by a method with the features of claim 1 and by a use with the features of claim 10. Preferred further developments of the invention are the subject matter of the subclaims. Further advantages and features of the present inventions are apparent from the general description and the description of the exemplary embodiment.

The method according to the invention serves for gripping and transferring at least one individual unit from a stock of stacked or layered individual units that are stacked or layered in an offset manner. Here, a system is used for gripping and transferring, which comprises at least one handling device with at least one gripping device and at least one controller, wherein the stock of individual units stacked or layered in an offset manner is provided on at least one storage surface. In doing so, the position and/or orientation of an individual unit on the storage surface is detected by means of the controller. Furthermore, the handling device and the gripping device are actuated by means of the controller on the basis of the ascertained position and/or orientation in order to grip the individual unit. Subsequently, the gripped individual unit is transferred to a specified location and/or unit.

The fact that the individual units are stacked in an offset manner means in particular that at least two and in particular more than two individual units are always arranged at least in sections at the very top of a storage surface. In this case, when individual units are stacked in an offset manner, certain regions are usually always covered by another individual unit.

According to the invention, the position of the uppermost individual unit is detected, which is exposed, i.e., which is at the very top and is not partially covered by other individual units. In this manner, it is detected if an individual unit is the uppermost individual unit of the stock, which can be freely removed or picked up. If multiple individual units are exposed at the same time, one is selected and it is taken into account that the storage surface is worked off as horizontal as possible and not inclined, or a hollow or a mountain is created.

Preferably, the individual units are gripped or can be gripped from a non-rigid ground. In this case, a non-rigid ground is in particular a ground or a surface or a contact surface which is at least slightly elastic or yields under pressure and which, in particular, is not rigid or hard or inelastic. However, it is also possible to grip individual units from a rigid or hard ground, e.g., the last layer of individual units on a pallet or the like.

Detecting the position and/or the orientation of the individual unit on the storage surface by means of the controller can in particular be detected automatically on the basis of the present situation, for example by means of sensor data or the like, and/or the position and/or orientation can also be stored in the controller.

However, detection by means of the controller can also be carried out manually by an operator if a user enters, for example, a specific position into the controller or actuates the gripping device accordingly.

Depending on the configuration, the position and/or orientation of individual units on the storage surface can be stored in the controller, for example if objects or individual units are placed at specified positions in a specified orientation.

Less error-prone is the automatic detection of the position and/or orientation of the individual units on the storage surface, for example by imaging and/or sensor-based methods. In particular, it is then also possible to take into account if an actually specified position or orientation is not given, for example if an operator subsequently places an individual unit on the storage surface and/or if individual units have slipped, for example during transport, or have been brought into a non-specified position or orientation in some other way.

The correction or actuation of unknown positions can also take place if a user manually notifies the controller about the orientation and/or position at which an individual unit is placed.

In particular, if an individual unit has a specific orientation or is to be transferred to the specified location and/or unit with a specific side or orientation, additionally or exclusively, the orientation of the individual unit on the storage surface can also be detected.

The individual units can in particular be piece goods or objects, which can preferably be provided in stacks or bundles on a storage surface. These individual units or bundles of individual units are stacked or layered, in particular in an offset manner. Thus, for example, an individual unit can be an empty sack, e.g., as used for filling bulk goods. In particular, it is intended that the individual units are substantially flexible, at least in sections. For example, any empty sacks or bags such as valve sacks, FFS sacks, open-mouth sacks or even bundles of paper bags or the like can also be picked up by the gripping device. Preferably, bundles of individual units also have a certain flexibility. For example, bundles of newspapers or stacks of thin cardboard or even, for example, stacks of sheets of paper or the like can also be gripped by means of the method and transferred to another specified location and/or unit.

A gripping device can in particular be configured as described in the exemplary embodiment. The applicant reserves the right to further define the invention on the basis of individual features of the gripping device or a combination of features.

The method according to the invention is particularly suitable for gripping and transferring stacks of empty sacks from a stock of sacks or a stock of stacks of sacks, for example stacks of layered sacks on a pallet. In particular, a stack of sacks can be gripped from a specific-namely the uppermost-position by means of the gripping device and transferred in a specific orientation to a conveyor belt or an automatic sack applicating device. This is particularly advantageous in order to transfer the upper open end or the valve of a valve sack in the correct orientation.

In order to check a correct transfer of an individual unit to a specific location and/or other unit, depending on the configuration, at least one camera can preferably be provided in order to monitor and/or document the transfer. It can be checked via the images or data from this camera, for example, whether the orientation of the individual unit during the transfer is actually correct and/or whether individual objects of an individual unit consisting of multiple objects, for example a stack of empty sacks, have slipped during the transfer. If an incorrectly gripped individual unit and/or a faulty individual unit is detected, this individual unit can then preferably be transferred, e.g., to an ejection point. This ensures, among other things, that only those individual units are transferred that can be processed further.

Depending on the configuration, it is also possible, for example, to check whether the storage location for the gripped individual unit is free or still occupied.

Depending on the configuration, the monitoring of the transfer location can preferably also be recorded by at least one other camera or camera device, which is provided at a different location.

The method according to the invention offers many advantages. A considerable advantage is that by detecting the position and orientation of the individual unit or individual units on a storage surface, it is possible to pick up individual units in a targeted manner.

According to the invention, in a stacked or layered stock of individual units, the uppermost or the or an exposed individual unit can be detected and subsequently gripped in a defined manner so that the individual unit can be transferred with a defined orientation for further processing.

Due to the targeted transfer of individual units in a specific orientation and/or from a specific position, automation can be achieved in many applications.

In advantageous configurations, the gripping device moves next to the piece goods to be gripped and, before gripping, rests at least in sections on the contact surface and/or an individual unit located at least in sections below the individual unit to be gripped.

Particularly preferably, the individual unit is an individual object or also a bundle and/or a stack of objects. Such an object is, in particular, at least one empty sack, wherein a bundle of such an object is then a stack of sacks, which is also defined as an individual unit. A stack of sacks may comprise, for example, 5, 10, or 15, or another number of sacks.

Particularly preferably, the handling device comprises at least one robot device with at least one robotic arm and/or is provided by at least one robot device with at least one robotic arm. By providing a robotic arm or a robot device as a handling device, a movement of the gripping device can be actuated particularly precisely and effectively in order to grip an individual unit whose position and/or orientation has been detected.

In useful further developments, the system comprises at least one camera device in operative connection with the controller, wherein the position and/or orientation of the individual unit to be gripped on the storage surface is ascertained by means of the data from the camera device. The controller ascertains the position and/or orientation of the individual unit from the data or images of the storage surface recorded by the camera and actuates the gripping device accordingly. In order to be able to accurately ascertain the orientation and/or position of an individual unit, the camera device is preferably attached above the storage surface, in particular in such a manner that the storage surface is in the detection area of the camera. By detecting the position and/or orientation by means of a camera device, automatic detection of individual units can take place so that preferably individual units added subsequently and/or individual units not placed in the specified position can also be reliably detected and detected by means of the gripping device.

The system preferably comprises at least one height detection means. With the height detection means, the handling device can actuate and grip with particular precision not only along the storage surface, but also in terms of height. In this manner, the approach height for the handling device or for the robot arm or the gripping device is ascertained so that in particular the uppermost individual unit or, in the case of sack bundles, the uppermost sack bundle can always be gripped. Such height detection means can use, for example, at least one laser, radar, ultrasound and/or the like to ascertain the height to be approached by the gripping device.

In preferred configurations, the height detection means is integrated into the camera device. If the height detection means is integrated into the camera device, no separate component is required and only the data set of a device needs to be read out.

The camera device is particularly preferably designed as a 3D camera or comprises at least one 3D camera. By means of a 3D camera, not only can the position on the storage surface be ascertained and approached, but the correct height is also automatically detected by the 3D camera and transferred to the controller, so that optimal actuation can take place in three-dimensional space.

Preferably, the approach accuracy of the gripping device in all and/or individual planes can be taught or improved via at least one automated application and/or at least one AI application (artificial intelligence). In particular, neural networks and/or machine learning and/or deep learning methods can be used. After teaching, the gripping device can preferably also work accurately offline.

In general, the position and/or orientation of an uppermost or exposed individual unit can be detected by at least one automated application and, in particular, at least one AI-based application, or the detection can be supported by it.

Preferably, the automated application comprises at least one AI application and/or at least one machine learning application and/or at least one computer vision application. By using artificial intelligence and/or machine learning and/or computer vision application, an individual unit can advantageously either be actively taught or detected from the previously learned “experience” of the AI application or the like. In a stock of individual units stacked in an offset manner, the uppermost or an exposed individual unit or its position and/or orientation can then reliably be detected by the automated application or the AI application and/or at least one machine learning application and/or at least one computer vision application. At the same time, the automated application can decide and determine from which of the four possible directions the individual unit can be gripped most safely.

This information is then transferred to the gripping device in order to ensure an optimal approach of the gripping device to the exposed individual unit, in particular from a specific side.

After an individual unit has been gripped and transferred, the position or orientation of an exposed individual unit is ascertained again and the data is forwarded to the gripping device.

Computer vision refers in particular to the analysis of images and videos by means of computer programs. The aim of these analyses is in particular to extract information contained in the image. Depending on the configuration, probabilistic methods, methods of image processing, projective geometry, deep learning and computer graphics are preferably used.

In the field of AI application, any application in the field of artificial intelligence can be used which can be used advantageously with regard to the respective intended evaluation of images, image data, data, and/or data sets.

The use of machine learning (ML) is particularly advantageous here, with machine learning being a sub-field of artificial intelligence (AI). A central component of machine learning are algorithms and methods that enable programs to learn from data without being explicitly programmed. This means that these programs can preferably make decisions independently.

A distinction is made between supervised, unsupervised and semi-supervised learning. Supervised learning methods include, among other things, convolutional neural networks (also known as space-invariant artificial neural networks) and further developments of convolutional neural networks, such as region-based convolutional neural networks. These modifications of conventional neural networks are in particular, but not exclusively, suitable for image processing applications since, depending on the configuration, one or more pre-processing steps are carried out before the neural network including, among other things, e.g., convolutional operations, depending on the application.

In particular, sensors (e.g., optical sensors such as a camera in color or black/white, thermal imaging, temperature sensors, vibration sensors, etc., . . . ) are used to record data of certain states and to store them in the respective controller.

The information obtained, processed and declared is then preferably transferred/taught to a CNN (convolutional neural network) by machine learning or AI methods or AI applications. When detecting individual units and in particular when detecting empty sacks and/or empty sack stacks, or when teaching, available image data of individual sacks, stacks of sacks and/or pallets is preferably first generated if not available, and a concept for pattern recognition is preferably created. Images of single sacks, which are preferably taken individually with different deformations in front of a single-color background, can be of particular importance here.

Preferably, interfaces are defined which are to be used to input the current camera image into the AI for classification and to output the position and orientation of the ascertained sack.

After reviewing the data and specifying the interfaces, various AI approaches are preferably tested with regard to their performance for the given problem. After the selection of suitable methods, the data is preferably prepared for AI training. This is preferably followed by AI training and the necessary iterations to stabilize the overall system in order to make it usable for productive use.

An AI application and/or other automated application taught in this manner is now preferably ready for use and is preferably then integrated into the required program flow. A software-based runtime environment that can operate the developed or defined interfaces is preferably developed for this purpose. The runtime is preferably optimized for the desired hardware and, in particular, equipped with simple diagnostic tools.

After AI training and optimization of the overall system, a test phase is preferably carried out to test the system under real conditions. Preferably, the data collected during the tests is then evaluated and adjustments are made to the system.

Preferably, teaching an AI application or an automated application is only initial, in particular with regard to individual units. In particular, this involves teaching what an individual unit looks like. As described above, it can be necessary to initially teach different types of individual units. This can involve different orientations and/or deformations of a sack type. However, different types of sacks can also be shown and taught to the AI application.

Preferably, however, after the teaching process, e.g., for empty sacks or of empty sack stacks, the situation is such that AI detects whether the individual unit is a sack or comprises sacks and, in particular, what kind of sacks are currently being used. This can include properties such as the size or dimensions, the material, whether it is a valve sack or an open-mouth sack and/or the like. Moreover, from this, it is then preferably possible to automatically infer from which side a sack or stack of sacks must be approached in order to transfer it in the correct orientation. Information as to which type of sack has been transferred for which product can also be transferred to the downstream machine control system, e.g., a packaging system for bulk goods. In this manner it can be ensured that the product to be filled and the packaging material match in order to avoid incorrect filling. This is particularly relevant if the unit transfers different sack types from two or more different storage surfaces to multiple packaging lines, some of which are different.

Also in accordance with the invention is the use of a system comprising at least one handling device with at least one gripping device and comprising at least one controller for gripping and transferring at least one individual unit, wherein the position and/or the orientation of an exposed individual unit in a stock of individual units stacked in an offset manner on a storage surface is detected by means of the controller and wherein the detected individual unit is gripped by means of the gripping device.

The use of such a system offers the same advantages as previously described for the method according to the invention.

Here too, the applicant reserves the right to further develop the gripping device with features, individually or in combination, which are described in more detail in the exemplary embodiment.

Preferably, the handling device is provided by at least one robot device with at least one robotic arm. By means of a robot device or by means of a robotic arm, the gripping device can be moved particularly advantageously, effectively and precisely in order to approach and grip an individual unit.

Particularly preferably, the system comprises at least one camera device by means of which the position and/or orientation of the individual unit to be gripped can be ascertained. Preferably, a 3D camera is used.

When using imaging methods, the uppermost or exposed individual unit is ascertained again via the recorded data after each transfer of an individual unit so that the gripping device can grip the currently uppermost or exposed individual unit.

Depending on the configuration, the positions and/or orientations can also be stored in the controller or entered manually by a user.

In useful further developments, the handling device is suitable and designed to grip individual units from at least two storage surfaces. Depending on the configuration of the system, the performance can be increased if, for example, during the placement of more individual units onto the storage surface or when replenishing the stock, another storage surface that is still full can be actuated. Depending on the configuration, the handling device can then transfer individual units from two storage surfaces to another unit or even from one storage surface to one unit and the other storage surface to another unit. The parallel feeding of one storage surface to at least two units and/or the feeding of at least two storage surfaces to at least two units can also be suitably provided, depending on the configuration.

In useful further developments, the camera device is provided to be movable between the storage surfaces. By movable it is to be understood in particular that the camera device or the detection area of the camera device can be moved back and forth between the storage surfaces if it is not possible to detect both storage surfaces simultaneously so that, depending on the storage surface used, this storage surface is also detected by means of the camera device.

Alternatively, if a camera device cannot detect both or multiple storage surfaces, at least one camera device can also be provided above each storage surface. Thus, depending on the configuration, it is preferred that at least two camera devices are provided, with in each case at least one camera device being arranged above the storage surface.

Further advantages and features of the present invention are apparent from the exemplary embodiment which is explained below with reference to the accompanying figures.

In the figures:

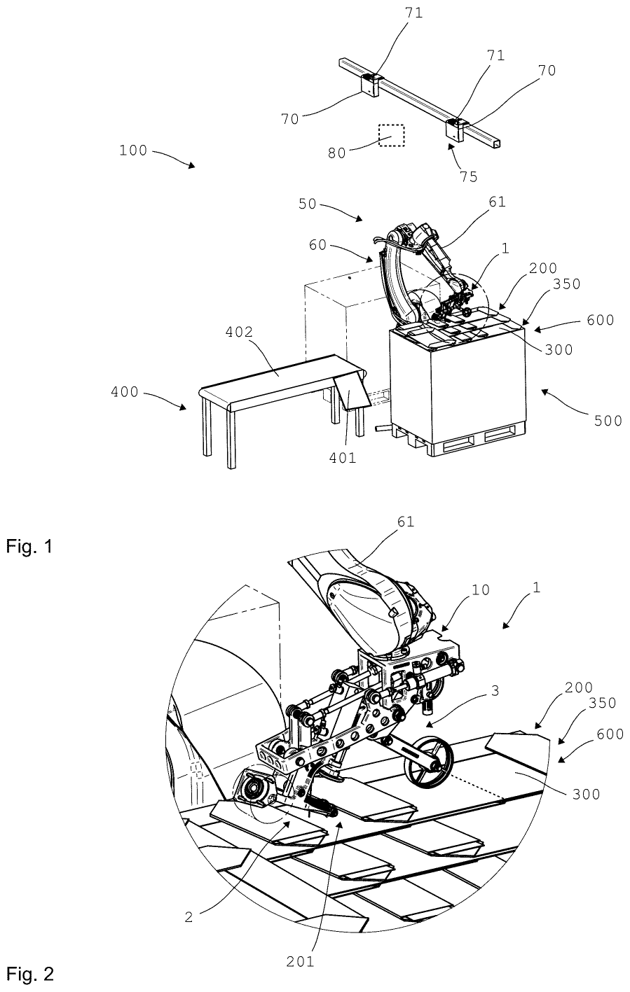

FIG. 1 shows a purely schematic diagram of an exemplary embodiment of a system according to the invention in a perspective view;

FIG. 2 shows a purely schematic enlarged diagram as shown in FIG. 1;

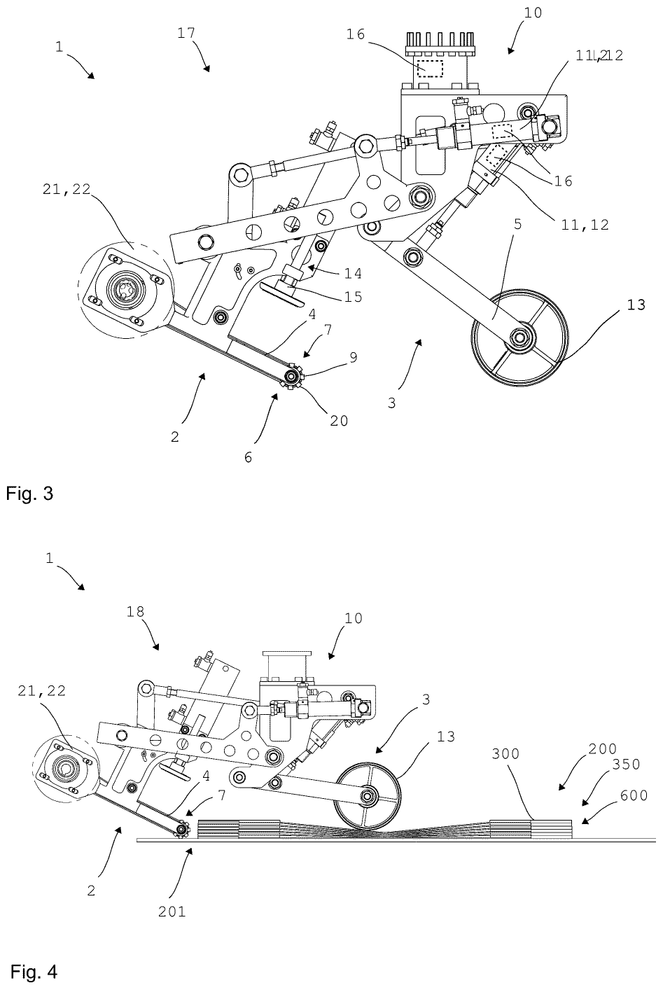

FIG. 3 shows a purely schematic diagram of an exemplary embodiment of a gripping device according to the invention in a side view;

FIG. 4 shows a purely schematic diagram of an exemplary embodiment of a gripping device according to the invention in a side view when gripping an individual unit;

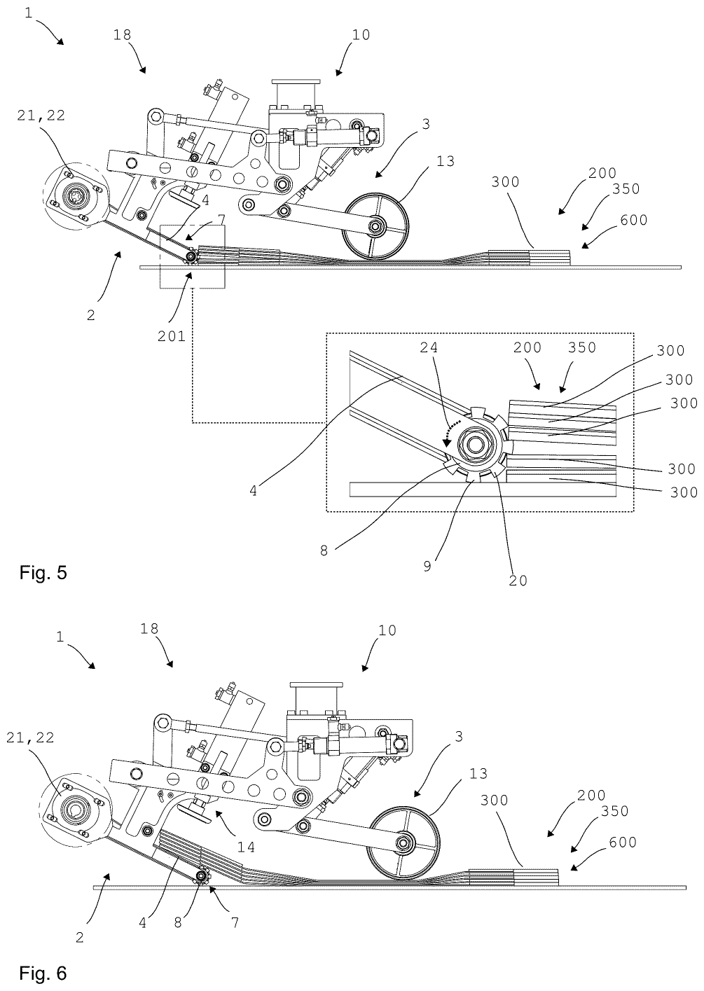

FIG. 5 shows a purely schematic diagram of an exemplary embodiment of a gripping device according to the invention in a side view when gripping an individual unit;

FIG. 6 shows a purely schematic diagram of an exemplary embodiment of a gripping device according to the invention in a side view when gripping an individual unit;

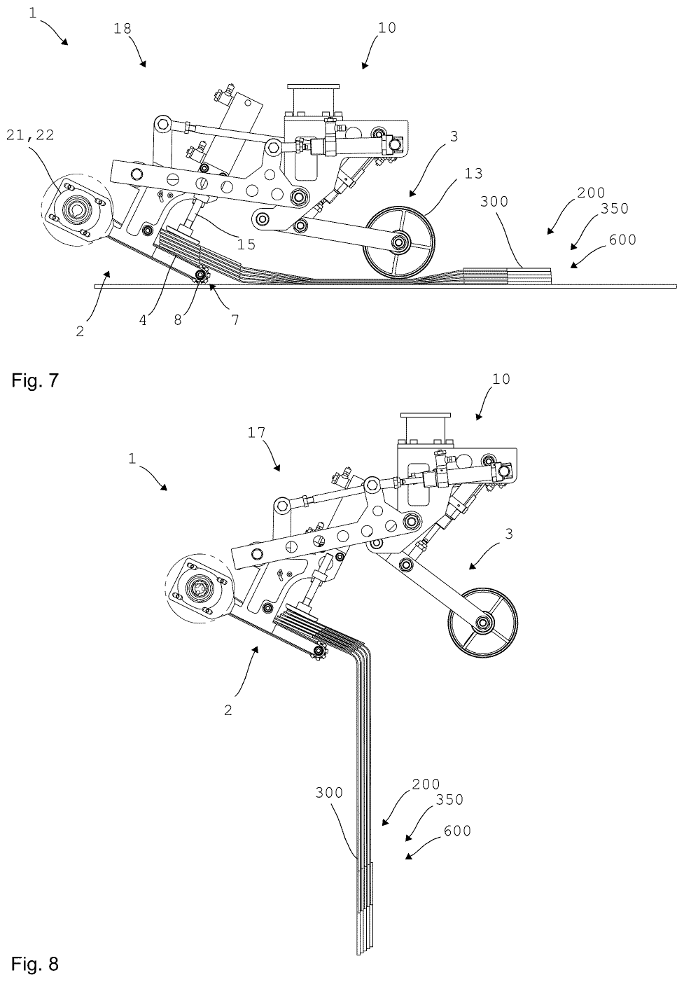

FIG. 7 shows a purely schematic diagram of an exemplary embodiment of a gripping device according to the invention in a side view when gripping an individual unit;

FIG. 8 shows a purely schematic diagram of an exemplary embodiment of a gripping device according to the invention in a side view when gripping an individual unit;

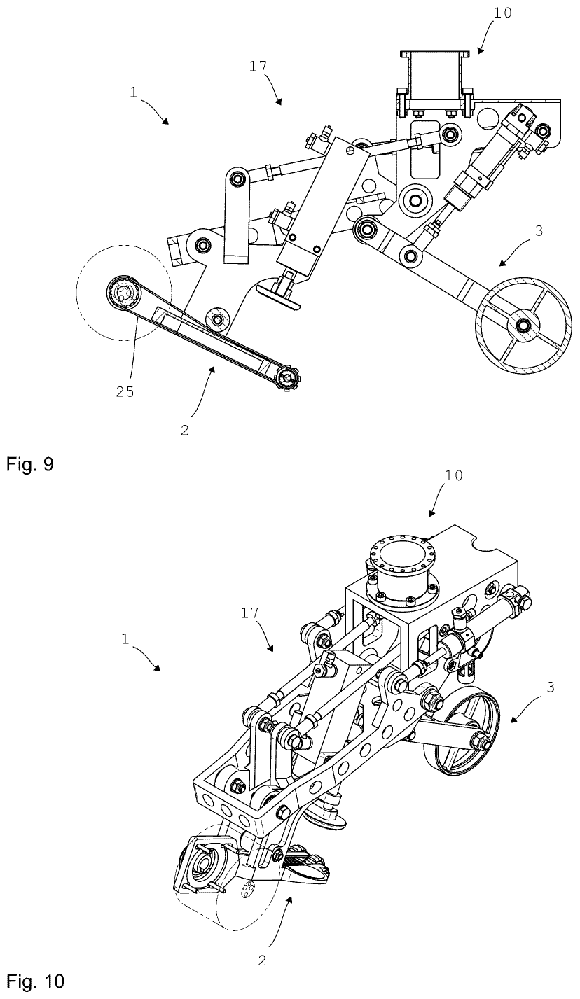

FIG. 9 shows a purely schematic diagram of an exemplary embodiment of a gripping device according to the invention in a sectional view from the side;

FIG. 10 shows a purely schematic diagram of an exemplary embodiment of a gripping device according to the invention in a perspective view;

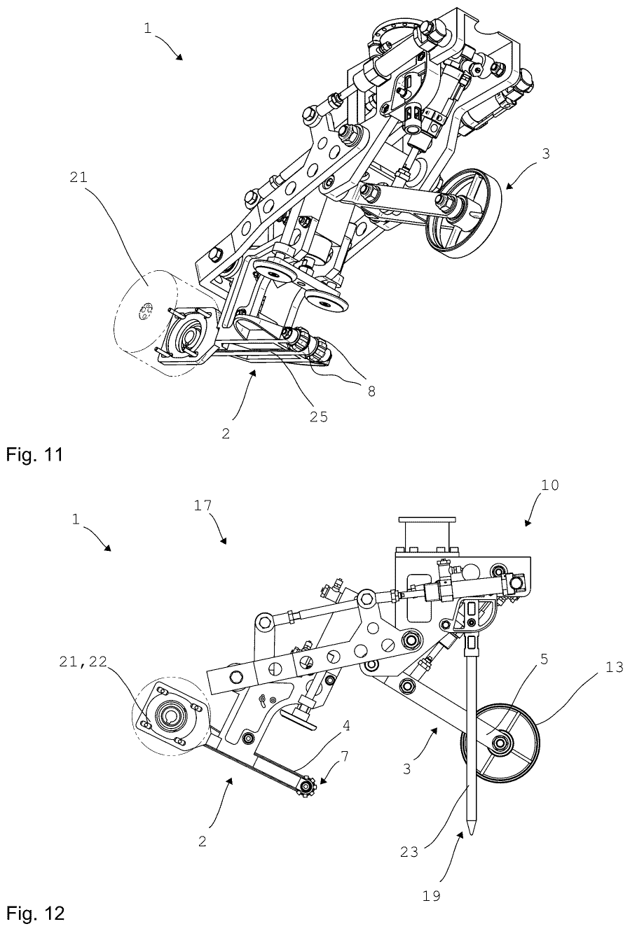

FIG. 11 shows a purely schematic diagram of an exemplary embodiment of a gripping device according to the invention in a further perspective view;

FIG. 12 shows a purely schematic diagram of an exemplary embodiment of a gripping device according to the invention in a sectional view from the side;

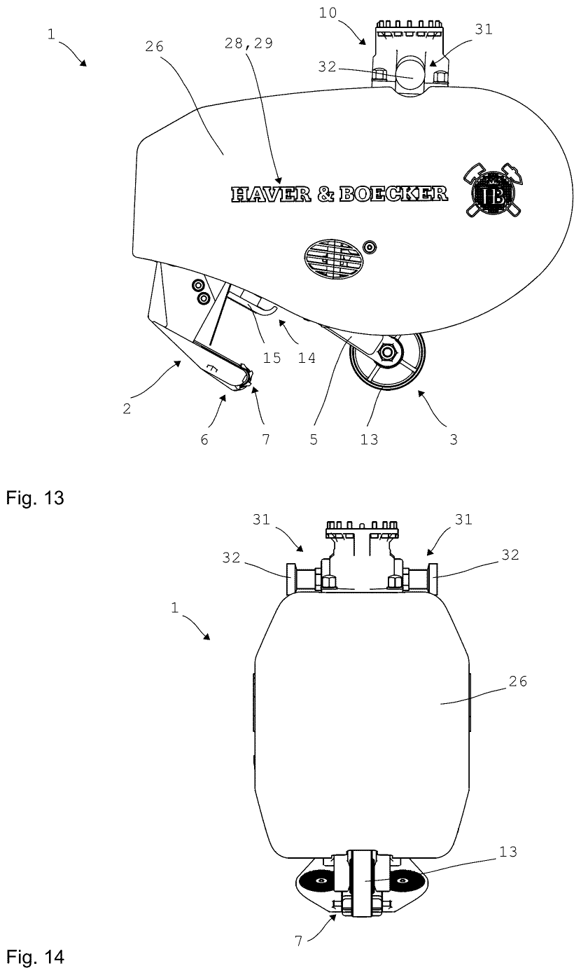

FIG. 13 shows a purely schematic diagram of a further exemplary embodiment of a gripping device according to the invention with a hood device in a side view;

FIG. 14 shows a purely schematic diagram of the exemplary embodiment according to FIG. 13 in a frontal view;

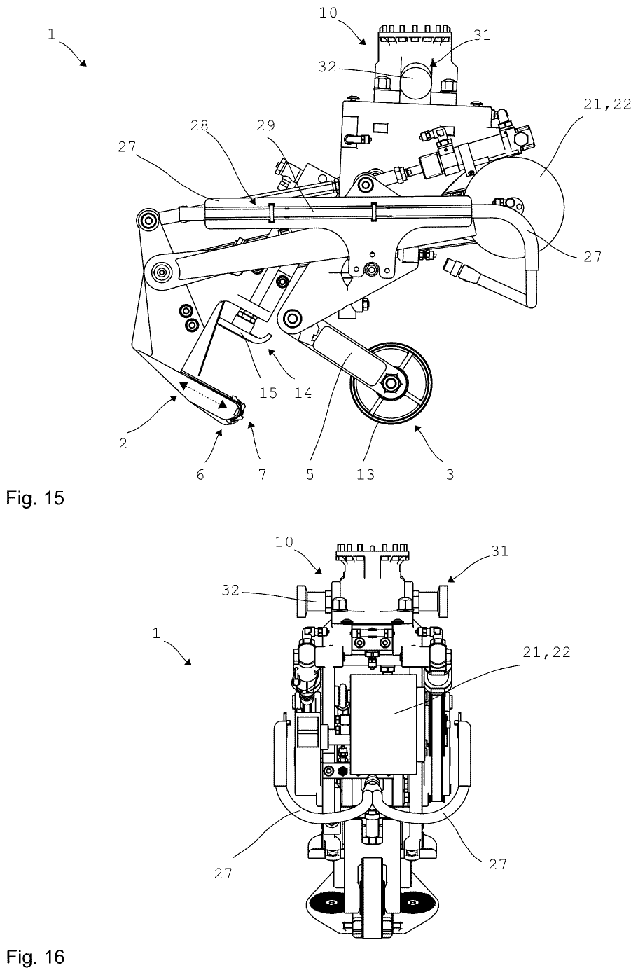

FIG. 15 shows a purely schematic diagram of a next exemplary embodiment of a gripping device according to the invention in a side view;

FIG. 16 shows a purely schematic diagram of the exemplary embodiment according to FIG. 13 in a frontal view;

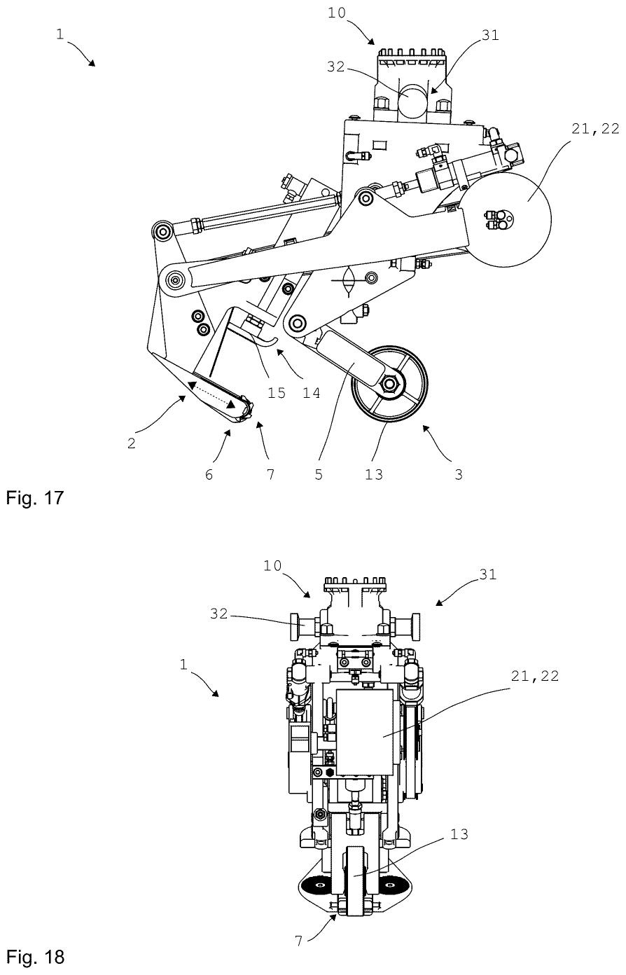

FIG. 17 shows the view according to FIG. 15 without fastening device for a hood device;

FIG. 18 shows the view according to FIG. 16 without fastening devices for a hood device;

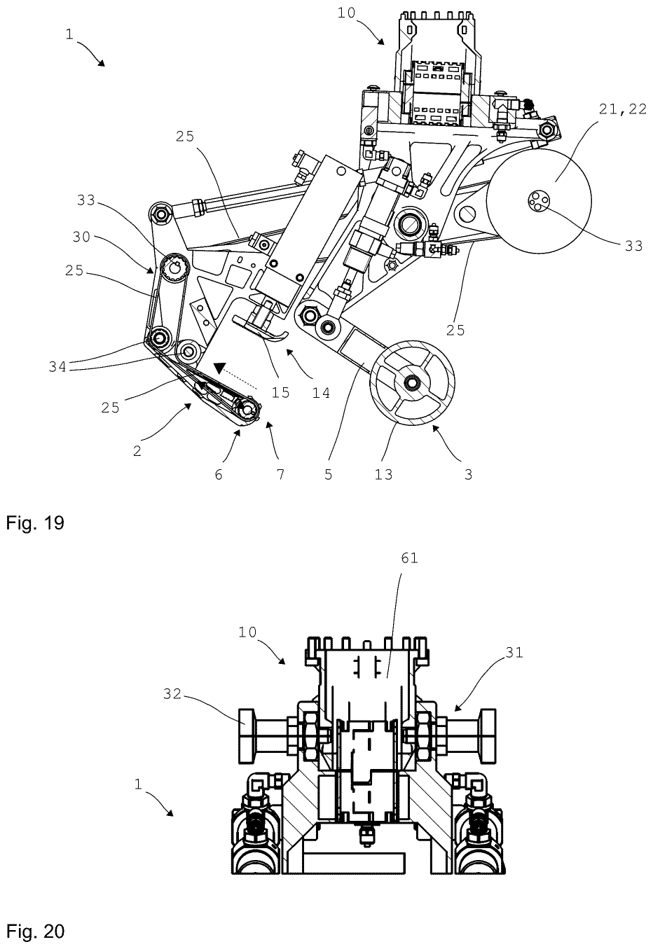

FIG. 19 shows a purely schematic sectional view of the exemplary embodiment according to FIG. 17; and

FIG. 20 shows a purely schematic sectional view of an exemplary embodiment example of a receiving unit with a quick-change device.

FIG. 1 purely schematically illustrates a system 100 according to the invention, which in the exemplary embodiment shown here comprises a handling device 50 and a controller 80. In the exemplary embodiment shown, the system according to the invention is used for gripping and transferring at least one individual unit 200 out of a stock of stacked individual units 200 from a storage surface 500 to a further unit 400. In the exemplary embodiment shown, the individual units are stacked in a layered manner on a pallet and thus provide a stock of individual units 200.

An individual unit 200, for example, is in particular a flat object which is stacked as stock and rests on the storage surface 500. However, an individual unit 200 can also be a stack or bundle 600 of objects, as in the example shown here, with the bundle or stack 600 then being gripped and transferred as an individual unit 200.

What is to be understood by an individual unit according to the application is further defined by way of example in the general description.

In the exemplary embodiment shown, the stacked objects are empty sacks 300, an individual unit 200 being provided here by a stack of sacks 350. In particular, stacks or empty sack stacks 350 of valve sacks are transferred from a pallet on the storage surface 500 to a further unit 400 by means of the handling device 50. In the exemplary embodiment shown, the further unit 400 is a conveyor belt 402 onto which the individual units 200 or the empty sack stacks 350 are transferred in a specified orientation, namely with the valve in a specified orientation on the conveyor belt 402. In the exemplary embodiment shown, this conveyor belt 402 is used to feed empty sacks 300 or individual empty sack stacks 350 to an automatic sack applicator which is connected upstream of a rotary packing system. The bag applicator and the packing system are not illustrated in the embodiment shown here.

In order to facilitate the placing of the gripped individual units 200 onto the conveyor belt 402 or to make it as accurate as possible, a depositing support 401 is provided here, which is designed here as an obliquely mounted plate.

To check the handling device 50 for correct transfer of the individual unit 200 to the further unit 400, or here to the conveyor belt 402, at least one further camera, which is not shown here, can be provided, depending on the configuration. The images or data from this camera can be used, for example, to check whether the orientation of the individual unit during the transfer is actually correct and/or whether individual empty sacks 300 have slipped during the transfer of an empty sack stack 350, for example. If an incorrectly gripped individual unit 200 and/or a faulty individual unit 200 is detected, it can then be transferred to an ejection point, for example. In this manner it can preferably be ensured, among other things, that only those individual units are transferred that can be processed further.

Depending on the configuration, it is then also possible, for example, to check whether the storage location for the individual unit 200 being gripped is free or still occupied. Depending on the detection area of the camera device 70, however, checking the transfer of the individual units 200 to the further unit 400 can also be carried out via this camera 70.

In the exemplary embodiment shown here, 50 comprises a robot 60 with a robotic arm 61, wherein a gripping device 1 according to the invention is attached to the free end of the robotic arm 61.

In order to be able to transfer a gripped individual unit 200 in a defined orientation by means of the handling device 50 to the further unit 400 or to a further location 400, the uppermost and thus exposed individual unit must first be known or detected in order to make sure not to grip individual units that are partially covered by other individual units 200. The gripping device 1 must then grip the uppermost or an exposed individual unit 200 in a defined manner at a specific edge 201, for which purpose the controller 80 must detect the position and/or orientation of the individual unit 200 on or in the stock of sacks or the stock of individual units 200 in order to actuate the gripping device 1 accordingly.

For this purpose, it is provided in the exemplary embodiment shown that a camera device 70 is provided above the storage surface 500, wherein the controller 80 detects the position and/or the orientation of the individual unit 200 to be gripped on the storage surface 500 via the evaluated data of the camera device 70. In the exemplary embodiment shown, the orientation is the orientation with respect to the position of the valve of the valve sack.

To make sure that the gripping device 1 can also approach the appropriate individual unit 200 at the correct height, a height detection means 75 is provided so that the robotic arm 61 can move the gripping device 1 precisely towards the correct individual unit 200 from a specified side or to the correct edge 201 of the correct individual unit 200.

Depending on the configuration, the height detection means 75 can be provided as a separate component, in particular if the camera device 70 itself cannot detect the height or distance to an individual unit 200. In the exemplary embodiment shown here, the camera device 70 is provided by a 3D camera 71 in which, accordingly, a height detection means 75 is integrated.

In the exemplary embodiment shown here, it is also shown that two storage surfaces 500 are arranged in operative connection with the handling device 50, with one storage surface 500 being provided here to the left and one to the right of the robot 60.

The handling device 50 can pick up individual units 200 from both storage surfaces 500, for example alternately or one after the other, and feed them to a unit and/or also supply two separate units with individual units 200 in parallel.

To make sure that the control of the gripping device 1 can precisely grip the respective individual unit 200, a camera device 70 is provided above each storage surface 500 in the exemplary embodiment shown here, both of which are designed here as a 3D camera 71.

Depending on the detection range of the camera device 70 used, it is also possible that only one camera device 70 is provided. In other embodiments it is also conceivable to use only one camera device 70 which is provided to be movable above the storage surfaces 500.

By means of the method according to the invention, the position and/or the orientation of the individual unit 200 to be gripped is ascertained by means of the controller. As already explained above, this means in particular that the controller 80 ascertains the position and/or the orientation of the individual units 200 on the storage surface, for example by means of acquired sensor data or, in the exemplary embodiment shown here, by means of the data of a camera device 70.

Depending on the embodiment, however, ascertainment by means of the controller is also possible in such a manner that, e.g., a specified layer pattern, for example of individual units 200 stacked on pallets in an offset manner, is entered into the controller 200, with the individual specified positions being scanned by means of the controller 80.

The advantage of automatic detection of the sack position or the position or orientation of an uppermost exposed individual unit 200 is that, for example, individual units 200 that are shifted during transport or individual units 200 that are subsequently placed by an operator are detected during automatic detection, so that errors cannot occur.

Ascertainment by means of the controller can also be achieved in that an operator, manually or by hand, informs the controller of a specific approach position.

FIG. 2 shows a purely schematic enlargement of the free end of the robotic arm 61 with the gripping device 1 according to the invention attached to it.

It is illustrated here that the gripping device 1 is received on the robotic arm 61 by means of a receiving unit 10, whereby the robotic arm 61 can move the gripping device 1 in any three-dimensional direction and can also rotate the gripping device 1 so that the gripping unit 2 of the gripping device 1 can be moved towards a specified side or to a detected edge 201 of the individual unit 200 to be gripped.

In the exemplary embodiment shown, the individual units 200 are empty sack stacks 350, here in particular valve sacks, which are present stacked in bundles 600 on a pallet. Thus, the individual unit 200 consists here of a bundle or stack 600 of empty sacks 300.

In the exemplary embodiment shown here, the gripping device 1 comprises a gripping unit 2 and a holding unit 3, wherein the gripping unit 2 and the holding unit 3 are connected to one another in an articulated manner by means of the receiving unit 10 in the exemplary embodiment shown here.

As already described above, the gripping device 1 is received on a robotic arm 61 or on a handling device 50. In the exemplary embodiment shown, the gripping unit 2 comprises a contact section 4 on which an individual unit 200 to be gripped and then to be transferred rests and is clamped by means of a fixing device 14.

In the exemplary embodiment shown here, the fixing device 14 comprises a fixing punch 15.

At the free end 6 of the contact section 4, a lifting device 7 is provided which in the exemplary embodiment shown here comprises a roller 8 or two rollers 8 arranged parallel to one another, which can be driven or rotated by means of a motor 21. In this case, a compressed air motor 22 is provided, which can drive the roller 8 in a specified direction 24 or, depending on the configuration, can also rotate the roller in both directions.

The motor is in operative connection with the roller 8. Any suitable power transmission can be used. Here, the roller 8 or the rollers are connected to the motor 21 via a toothed belt 25 in order to effect a transmission of force or rotation to the roller 8. Depending on the configuration, multiple toothed belts and/or other power transmission means can also be provided. Thus, it is also possible to arrange the motor 21 at almost any location via multiple toothed belts or the like, for example to obtain a better weight distribution and/or to have fewer interfering contours when approaching an individual unit 200.

In the exemplary embodiment shown, the roller 8 comprises a contact-imparting structure 9, which is designed here as a type of external toothing or as nubs or grooves. In addition, in the exemplary embodiment shown, the roller 8 comprises a friction- or adhesion-enhancing surface 20. In the exemplary embodiment shown, this surface is provided by a rubber coating.

Depending on the configuration, it can also be sufficient to provide only a contact-imparting structure 9 or only an adhesion-enhancing surface 20.

How the lifting device 7 lifts an individual unit 200 to be gripped so that the contact section 4 can be shifted under the individual unit 200 to be gripped is explained in more detail in the following figures.

In the exemplary embodiment shown here, the holding unit 3 comprises a holding element 5, with a holding roller 13 being provided at the free end of the holding element 5. The function of the holding element 5 or the holding roller 13 is explained in more detail in the following figures.

In addition, the individual elements or units of the gripping device 1 in the exemplary embodiment shown are partially equipped or connected with actuators 11, the actuators 11 being provided here by pneumatic cylinders 12. As a result, it is possible that the gripping device 1 or the arrangement of gripping unit 2 and holding unit 3 in the exemplary embodiment shown are in a first end position 17 in the freely suspended state, and that the gripping device 1 or the gripping unit 2 and the holding unit 3 are in a second end position 18 during the picking up or gripping of an individual unit 200. In the exemplary embodiment shown, the corresponding positions 17, 18 can be detected via a limit switch 16. As indicated in the figure, the limit switch 16 can be provided, for example, on the holding unit 10 and/or on at least one actuator 11 such as a pneumatic cylinder 12. When arranged on a pneumatic cylinder 12, for example, the retraction of the pneumatic cylinder 12 or a certain end position 17, 18 can be detected by the fact that the piston rod of the cylinder 12 passes sensors and thereby triggers the limit switch 16.

FIG. 3 shows the freely suspended configuration of a gripping device 1 according to the invention, wherein in this state, the gripping device 1 approaches an individual unit 200 to be gripped.

The gripping device 1 can approach the individual unit from any side of the individual unit. This can be particularly advantageous if layer images of individual units 200 are provided in which certain sides of at least some individual units 200 are not freely accessible.

Depending on the format of the individual units 200 to be gripped, the distance between the gripping unit 2 or contact section 4 or lifting device 7 and holding section 3 or holding element 5 can then also be changed and/or adjusted.

First of all, the position and/or orientation of an individual unit 200 to be gripped in a stock of individual units 200 on a storage surface 500 is ascertained or detected in the manner described above in accordance with the invention. In this manner, the contact section 4 can be moved next to a specified side or next to a specified edge 201 of the individual unit 200 to be gripped.

Since the individual unit 200 is gripped from a defined side or from a defined edge 201, it can also be transferred in a defined manner to a further unit 400, so that, for example, in the exemplary embodiment shown, valve sacks can be placed on a conveyor belt 402 with a certain orientation so that the individual sacks 300 can be transferred to a sack applicator with the valve in a defined position.

Once the position and/or orientation of an individual unit 200 to be gripped has been detected, the gripping device 100 is moved by means of the robotic arm 100 in the correct orientation towards an individual unit 200 to be gripped until the gripping unit 2 or the contact section 4 is present next to the individual unit 200 to be gripped on the corresponding specified side or next to the specified edge 201. In this state, the holding unit 3 or the holding element 5 is located above the individual unit 200 to be gripped and the gripping device 1 is still in the first end position 17 in the exemplary embodiment shown here. This position is ascertained in this exemplary embodiment via the evaluation of the camera images and/or the height detection means 75.

In all configurations, the approach accuracy of the gripping device in all and/or individual planes can be taught and/or improved preferably via at least one AI application (artificial intelligence), depending on the design. In particular, neural networks and/or machine learning and/or deep learning methods can be used for this purpose. After the teaching, the gripping device (1) can then preferably also work accurately offline, i.e., without AI in the background,

FIG. 4 shows that the gripping device 1 is subsequently lowered further until the contact section 4 rests on the same plane, in particular with a specified force, as the individual unit 200 to be gripped, wherein depending on the configuration, the contact section 4 may not be present completely and/or may be slightly spaced from the contact plane of the individual unit 200. In this position, the gripping device 1 is in the second end position 18, which is detected here by the limit switch 16. Depending on the configuration, however, the second end position 18 can also be detected by the height detection means 75.

As the gripping device 1 continues to move down, the holding element 5, or, in the exemplary embodiment shown, the holding roller 13 comes into contact with the individual unit 200 to be gripped, thereby shifting the position of the gripping unit 2 and holding unit 3 to the second end position 18.

Depending on the configuration, the controller 80 or a limit switch 16 can detect through the second end position 18 that the gripping device 1 cannot or must not be moved down any further.

In FIG. 5, the overall view and the enlarged view show the free end 6 of the contact section 4 with the roller 8. It is illustrated how the lifting device 7 lifts the individual unit 200 to be gripped so that the contact section 4 can be shifted under the individual unit 200 to be gripped.

For this purpose, the roller 8 in the exemplary embodiment shown here or in the view shown here is rotated counterclockwise in the specified direction of rotation 24 by means of the motor device 21, so that the contact-imparting structure 9 or the adhesion-enhancing surface 20 flips through the individual objects or here empty sacks 300 of the empty sack stack 350 or the individual unit 200, so to speak, and thereby lifts them. In this case, the preferred direction of rotation 24 is provided in such a manner that it results in an upwardly directed effective direction such that the individual unit 200 is moved upwards and the contact section 4 can be shifted under the individual unit 200.

In FIG. 6, it can be seen that after lifting and, depending on the configuration, also during lifting, the robotic arm 61 moves the gripping device 1 to the right in the exemplary embodiment shown, whereby the contact section 4 is shifted under the individual unit 200 to be gripped. The shifting is supported or simplified here by the fact that the holding element 5 comprises a holding roller 13, which rolls over the individual unit to be gripped in accordance with the shifting of the gripping device 1 by means of the robotic arm 61.

As can be seen, the individual unit 200, in this case the empty sack stack 350, is preferably at least slightly flexible so that it bends slightly by pressing it down by means of the holding element 5 or the holding roller 13 and by lifting it by means of the lifting device.

Depending on the configuration, the lifting device 7 or the roller 8 can also be further rotated or driven to 100 during the shifting of the contact section 4 under the individual unit to be gripped, should this be necessary. This supports the placement of the individual unit 200 onto the contact section 4.

As already shown in FIG. 6, FIG. 7 shows that the contact section 4 has been shifted under the individual unit 200 to be gripped so that the individual unit 200 or the edge section thereof rests on the contact section 4 of the gripping unit 2.

In order for the gripping device 1 to be able to also lift the individual unit 200 or here the empty sack stack 350, a fixing device 14 with a fixing punch 15 is provided in the exemplary embodiment shown, which here clamps the individual unit 200 on the contact section 4.

FIG. 8 shows that the robotic arm 61 lifts the gripping device 1 including the gripped individual unit 200, whereby the individual unit 200 now hangs on the contact section 4. In this manner, the individual unit 200 can be transferred.

By lifting the gripping device 1, the first end position 17 of gripping unit 2 and holding unit 3 is again assumed in the exemplary embodiment shown. The robotic arm 61 or the gripping device 1 can now move and/or rotate in such a manner that the gripped individual unit 200 is transferred to another unit 400 in a specified orientation.

In FIGS. 9 to 11, a lateral sectional view and two perspective views of exemplary embodiments of gripping devices 1 according to the invention are shown purely schematically in order to illustrate a possible configuration of gripping devices 1 according to the invention in even greater detail.

FIG. 12 shows purely schematically that the gripping device 1 can comprise a referencing device 19, which is designed as a rod 23 in the exemplary embodiment shown here.

This referencing device 19 is used here for the initial installation of the system 100, wherein an initial alignment, in particular between height detection means 75 or 3D camera 71 and handling device 50 can be carried out by means of the referencing device 19. In particular, by means of the referencing device 19 placed onto a specified surface, it can be detected by means of the controller 80 which height the gripping device 1 has assumed when the height detection means 75 detects a certain height.

In addition, a movement adjustment can be carried out or an interference contour during the rotation of the gripping device 1 can be adjusted by means of a referencing device 19 so that the controller 80 can prevent a collision with other components, individual units, and/or objects during movement and also during rotation, in particular during simultaneous movement and rotation.

FIGS. 13 and 14 show in purely schematic views from the side and front a further exemplary embodiment of a gripping device 1 with a hood device 26, which here provides a protective hood.

This hood device 26 protects the mechanics of the gripping device in particular against dust, or dirt, and collisions. As a result, in the exemplary embodiment shown, maintenance intervals can be extended and in the event of a collision, only the hood device 26 is usually damaged and not the sometimes sensitive mechanics of the gripping device 1.

In the exemplary embodiment shown here, a display device 28 with an illumination device 29 is assigned to the hood device 26 or these components are comprised by the hood device 26. Here, a display device 28 in the form of an illumination device 29 is arranged behind the hood device 26, which, through the logo which is transparent here, provides a status display on the sides of the gripping device 1. Depending on the status, the logo can then be illuminated in different colors.

The display device 28 or the lighting device 29 can be integrated, for example, into a fastening device 27 of the hood device 26, which is covered here by the hood device 26 or is assigned to it.

The receiving unit 10, by means of which the gripping device 1 can be fastened, e.g., to a robotic arm, comprises a quick-change device 31 in the exemplary embodiment shown here so that the entire gripping device can be installed and uninstalled quickly and easily by actuating the bolt or bolt 32.

In the exemplary embodiment shown, the hood device 26 does not cover the quick-change device so that the gripping device can also be changed and installed with the hood device being installed.

FIGS. 15 and 16 show purely schematic views from the side and front of a next exemplary embodiment of a gripping device 1.

In this exemplary embodiment, too, a hood device 26 can be installed. For this purpose, the gripping device 1 comprises a fastening device 27, or fastening devices 27 are provided on the left and right sides of the gripping device 1.

In the exemplary embodiment shown, the fastening devices 27 comprise a display device 28 or an illumination device 29. With a correspondingly designed hood device 26, a status display as shown in FIGS. 13 and 14 can then be achieved, for example.

The basic structure of the gripping device 1 or the gripping unit 2 and the holding unit 3 is very similar to the exemplary embodiments shown in FIGS. 3 to 13. However, in the exemplary embodiment shown here, the motor 21 or the compressed air motor 22 is not provided directly on the contact section 4, but in relation thereto downstream and below the receiving unit 10. In order to drive the rollers 8 of the lifting device 7, a deflection device 30 is provided which transmits the rotation of the motor 21 to the rollers 8 by means of multiple belts 25 or toothed belts and drive shafts 33 and deflection rollers 34.

Furthermore, it is indicated in FIG. 15 by the dashed double arrow that in all exemplary embodiments, the contact section 4 can be telescopic and/or that a certain length compensation can be achieved in a different manner. Thus, the contact section 4 can be optimally adapted to the dimensions of an individual unit 200 to be gripped, for example an empty sack 300 or an empty sack stack 350.

In FIGS. 17 and 18, the exemplary embodiment according to FIGS. 14 and 15 is again shown in a purely schematic view from the side and in a front view.

In these illustrations, the fastening device 27 for the hood device 26 is not shown in order to show the components therebehind.

In FIG. 19, the view according to FIG. 17 is again shown in a sectional view in which the deflection device 30 is easier to identify.

In FIG. 20, a sectional view through the receiving unit 10 of an exemplary embodiment of a gripping device 1 with a quick-change device 31 is shown.

Here, the spring-loaded bolts 32 can be seen, which are pulled out to the left and right to change the gripping device 1, causing the gripping device 1 to detach from a robotic arm 61, for example.

Reference list

| | |
|---|---|
| 1 | gripping device |
| 2 | gripping unit |
| 3 | holding unit |
| 4 | contact section |
| 5 | holding element |
| 6 | free end |
| 7 | lifting device |
| 8 | roller |
| 9 | contact-imparting structure |
| 10 | receiving unit |
| 11 | actuator |
| 12 | pneumatic cylinder |
| 13 | holding roller |
| 14 | fixing device |
| 15 | fixing punch |
| 16 | limit switch |
| 17 | first end position |
| 18 | second end position |
| 19 | referencing device |
| 20 | adhesion-enhancing surface |
| 21 | motor |
| 22 | compressed air motor |
| 23 | rod |
| 24 | direction of rotation |
| 25 | toothed belt |
| 26 | hood device |
| 27 | fastening device |
| 28 | display device |
| 29 | illumination device |
| 30 | deflection device |
| 31 | quick-change device |
| 32 | bolt |
| 33 | drive shaft |
| 34 | deflection roller |
| 50 | handling device |
| 60 | robot |
| 61 | robotic arm |
| 70 | camera device |
| 71 | 3D camera |
| 75 | height detection means |
| 80 | control device |
| 100 | system |
| 200 | individual unit |
| 201 | edge |
| 300 | empty sack |
| 350 | empty sack stack |
| 400 | unit |
| 401 | depositing support |
| 402 | conveyor belt |
| 500 | storage surface |
| 600 | bundle/stack |

1. A method for gripping and transferring at least one individual unit out of a stock of individual units, which are stacked in an offset manner, using a system comprising at least one handling device with at least one gripping device and at least one controller, wherein at least the stock of individual units, which are stacked in an offset manner, is provided on at least one storage surface, and wherein the individual unit is a bundle and/or a stack of objects,
the following steps, include:
detecting the position and/or orientation of an exposed individual unit on the storage surface by means of the controller;
actuating the handling device and the gripping device by means of the controller on the basis of the ascertained position and/or orientation in order to grip the individual unit, wherein the gripping device approaches the individual unit to be gripped from a side of the individual unit; and
transferring the gripped individual unit to a specified location and/or unit.

2. (canceled)

3. The method according to claim 1, wherein the handling device is provided by at least one robot device with at least one robotic arm.

4. The method according to claim 1, wherein the system comprises at least one camera device in operative connection with the controller, and wherein the position and/or the orientation of the individual unit to be gripped on the storage surface is ascertained by means of the data of the camera device.

5. The method according to claim 1, including at least one height detection means.

6. The method according to claim 5, wherein the height detection means is integrated into a camera device.

7. The method according to claim 4, wherein the camera device comprises at least one 3D camera.

8. The method according to claim 1, wherein at least one automated application and/or at least one AI application detects or assists in detecting an exposed individual unit and its position and/or its orientation.

9. The method according to claim 1, wherein at least one automated application and/or at least one AI application improves the approach accuracy of the gripping device to an individual unit to be gripped.

10. A use of a system, comprising at least one handling device with at least one gripping device and comprising at least one controller for gripping and transferring at least one individual unit, wherein the individual unit is a bundle and/or a stack of objects, wherein the position and/or the orientation of an exposed individual unit in a stock of individual units stacked in an offset manner on a storage surface is detected by means of the controller, and wherein the detected individual unit is gripped by means of the gripping device, wherein the gripping device approaches the individual unit to be gripped from a side of the individual unit.

11. The use according to claim 10, wherein the handling device is provided by at least one robot device with at least one robotic arm.

12. The use according to claim 10, wherein the system comprises at least one camera device by means of which the position and/or the orientation of the individual unit to be gripped can be ascertained.

13. The use according to claim 11, wherein the handling device is suitable and designed to grip individual units from at least two storage surfaces.

14. The use according to claim 13, wherein a camera device is provided to be movable between the storage surfaces.

15. The use according to claim 13, wherein at least two camera devices are provided, wherein in each case at least one camera device is arranged above a storage surface.
